(19) United States
(12) Patent Application Publication
(10) Pub. No.: US 2023/0297487 A1
(43) Pub. Date: Sep. 21, 2023

(54) METHOD AND APPARATUS FOR ESTIMATING EXECUTION TIME OF NEURAL NETWORK

(71) Applicants: Samsung Electronics Co., Ltd., Suwon-si (KR); Industry-Academic Cooperation Foundation, Yonsei University, Seoul (KR)

(72) Inventors: Myeong Woo KIM, Suwon-si (KR); Kunwoo KIM, Seoul (KR); Changsu KIM, Seoul (KR); Hanjun KIM, Seoul (KR)

(73) Assignees: Samsung Electronics Co., Ltd., Suwon-si (KR); Industry-Academic Cooperation Foundation, Yonsei University, Seoul (KR)

(21) Appl. No.: 17/889,135

(22) Filed: Aug. 16, 2022

(30) Foreign Application Priority Data
Mar. 15, 2022 (KR) 10-2022-0032400

(51) Int. Cl. G06F 11/34; G06F 11/30

(52) U.S. Cl. CPC G06F 11/3423; G06F 11/3037

(57) ABSTRACT

A method and apparatus for estimating execution time of a neural network are provided, the method of estimating execution time of a neural network in a multi-core accelerator, the method including generating trace information including operation timing information for each core of the multi-core accelerator, and calculating the execution time of the neural network reflecting communication overhead between cores of the multi-core accelerator and memory access time for each core of the cores, based on the trace information.

### CROSS-REFERENCE TO RELATED APPLICATIONS

This application claims the benefit under 35 USC § 119(a) of Korean Patent Application No. 10-2022-0032400, filed on Mar. 15, 2022, in the Korean Intellectual Property Office, the entire disclosure of which is incorporated herein by reference for all purposes.

### BACKGROUND

### 1. Field

The following description relates to a method and apparatus for estimating the execution time of a neural network reflecting a structure of a multi-core accelerator.

### 2. Description of Related Art

Deep learning may refer to creating a large number of layers in an artificial neural network and training the artificial neural network. Deep learning is being implemented in various fields, such as an autonomous driving, natural language processing, voice recognition, and data analysis associated with big data. A structure of a deep learning model is a structure in which a plurality of layers are included, for example, the number of channels for each layer, a dimension, and the number of parameters may be variously determined depending on a type of the deep learning model to be embodied.

In developing deep learning inference software through hardware including various computing platforms, structural characteristic of the hardware and characteristics of a data processing structure for embodying the deep learning model may be considered, and previous work related to optimizing these characteristics for deep learning model have been conducted.

Typically, in relation to a convolutional neural network, there are a weight stationary technique for maximizing a re-use of a filter, an output stationary technique for maximizing a re-use of a partial sum, and a row stationary technique for generating various re-uses in a way of processing one row by each of cores of a processing device. However, such conventional techniques are not performed by considering all possible optimization methods, and therefore, there is a limitation that algorithms may be restrictedly applicable based on a developer's heuristic.

In other words, a technique for automatically optimizing a deep learning task assignment to show the best performance, based on the property of the computing platform on which the deep learning model is embodied, has not been disclosed until the present, and accordingly, development of such a technique is required.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a processor-implemented method of estimating execution time of a neural network in a multi-core accelerator, the method including generating trace information including operation timing information for each core of the multi-core accelerator, and calculating the execution time of the neural network reflecting communication overhead between cores of the multi-core accelerator and memory access time for each core of the cores, based on the trace information.

The generating of the trace information may include generating one or more nodes for each layer of the layers of neural network, and generating a node graph corresponding to the neural network by connecting a data dependency between the one or more nodes via an edge.

The generating of the trace information may include extracting operation information of the neural network based on the node graph, acquiring a hardware information, determining estimated execution time for the each layer based on the operation information and the hardware information, and generating a weighted node graph based on the estimated execution time for the each layer.

The determining of the estimated execution time may include determining the estimated execution time for a single-core accelerator to execute the layers.

The generating of the weighted node graph may include generating the weighed node graph by adding the estimated execution time for the each layer as a node weight of the node graph.

The generating of the trace information may include partitioning the weighted node graph into a plurality of partitions, based on the estimated execution time for the each layer and a size of input and output data between the nodes.

The partitioning of the weighted node graph may include partitioning the weighted node graph into the plurality of partitions based on the execution time of each of the plurality of partitions having a difference equal to or lesser than a threshold time.

The partitioning of the weighted node graph may include setting each of the nodes as a single preliminary partition, and merging the preliminary partition until a number of final partitions becomes less than a number of cores, based on a balanced graph partitioning algorithm.

The generating of the trace information may include assigning the plurality of partitions to the cores to make communication overhead between the plurality of partitions equal to or lesser than a threshold.

The assigning of the plurality of partitions may include mapping partitions having a large amount of communication to adjacent cores, based on accelerator topology information included in the hardware information.

The generating of the trace information may include generating trace code including the operation timing information for each core to execute the plurality of partitions that are assigned to the each core.

The generating of the trace code may include generating the trace code that may include at least one of a read/write command including a memory address and a data size, data movement information between the cores, or operation timing information performed in each core.

The calculating of the execution time of the neural network may include executing a network on chip (NoC) simulator by decoding the trace information.

The calculating of the execution time of the neural network may include acquiring the memory access time for each core, based on at least one of a memory address or a size, and acquiring read information and write information between the cores based on the trace information.

The acquiring of the memory access time may include acquiring the memory access time for each core by interworking with a memory simulator.

The acquiring of the read information and the write information may include generating a write packet based on the trace information, and transmitting the write packet through a router, transmitting a read request to a network controller, based on the trace information, transmitting, by the network controller, the read request to a target core to generate a read packet, and receiving the read packet through the router.

In another general aspect, there is provided an apparatus for estimating execution time of a neural network, the apparatus including a compiler configured to generate trace information including operation timing information of the neural network for each core of a multi-core accelerator, and a simulator configured to calculate the execution time of the neural network reflecting communication overhead between cores of the multi-core accelerator and memory access time for each core of the cores, based on the trace information.

The compiler may be configured to determine estimated execution time for each layer of the neural network based on operation information of the neural network and a hardware information of the multi-core accelerator, and to generate a weighted node graph based on the estimated execution time for the each layer.

The simulator may be configured to acquire the memory access time for each core, based on at least one of a memory address or a size, and to acquire read information and write information between the cores, based on the trace information.

Other features and aspects will be apparent from the following detailed description, the drawings, and the claims.

### BRIEF DESCRIPTION OF THE DRAWINGS

FIG. 1 is a diagram illustrating an example of an apparatus for estimating execution time of a neural network.

FIG. 2 illustrates an example of an operation method of a node performance estimator.

FIG. 3 illustrates an example of an operation method of a partitioner.

FIG. 4 illustrates an example of an operation method of a partition-core mapper.

FIG. 5 illustrates an example of an operation method of a code generator.

FIG. 6 illustrates an example of an operation method of a network on chip (NoC) simulator.

FIG. 7 illustrates an example of a design space of a multi-core accelerator.

FIGS. 8A and 8B illustrate examples of an estimation of performance for a parallelism.

FIG. 9 is a diagram illustrating an example of a method of estimating execution time of a neural network.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular examples only and is not to be limiting of the examples. As used herein, the singular forms “a”, “an”, and “the” are intended to include the plural forms as well, unless the context clearly indicates otherwise. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

Although terms such as first, second, third, A, B, C, (a), (b), (c), and the like may be used herein to describe components. Each of these terminologies is not used to define an essence, order or sequence of a corresponding component but used merely to distinguish the corresponding component from other component(s). For example, a “first” component may be referred to as a “second” component, or similarly, and the “second” component may be referred to as the “first” component.

It will be understood that when a component is referred to as being “connected to,” or “coupled to” another component, the component can be directly connected or coupled to the other component or intervening components may be present. In contrast, when an element is referred to as being “directly connected to,” or “directly coupled to” the other component, there can be no other elements intervening therebetween. Likewise, similar expressions, for example, “between” and “immediately between,” and “adjacent to” and “immediately adjacent to,” are also to be construed in the same way.

The terminology used herein is for the purpose of describing particular examples only and is not to be limiting of the examples. As used herein, the singular forms “a”, “an”, and “the” are intended to include the plural forms as well, unless the context clearly indicates otherwise. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

The use of the term “may” herein with respect to an example or embodiment (e.g., as to what an example or embodiment may include or implement) means that at least one example or embodiment exists where such a feature is included or implemented, while all examples are not limited thereto.

The examples may be implemented in various forms of products, for example, a personal computer (PC), a laptop computer, a tablet computer, a smartphone, a television (TV), a smart home appliance, an intelligent vehicle, a kiosk, and a wearable device. Hereinafter, examples will be described in detail with reference to the accompanying drawings. When describing the examples with reference to the accompanying drawings, like reference numerals refer to like components and a repeated description related thereto will be omitted.

The conventional technique of estimating execution time of a neural processing unit (NPU) accelerator has limitations such as an absence of considering memory access time, an absence of considering communication overhead between cores in a many-core or multi-core accelerator (e.g., an NPU), and an absence of reflection of performance change according to a compiler optimization.

As a scale of a deep neural network (DNN) application increases, input data and weight data may need to be stored in an external memory (e.g., dynamic random-access memory (DRAM)). Since the conventional system assumes that all data exists in a local memory, performance overhead according to an external memory access may not be reflected. For multi-core accelerator, bottlenecks occurs when a plurality of cores access a memory at the same time.

In a case of the multi-core accelerator, since the plurality of cores independently exchange data by using a common data path, performance degradation may occur due to communication contention between the cores. Relates arts, such as Timeloop and MAESTRO, do not consider performance degradation due to the communication contention, and therefore, an accurate estimation of performance of the multi-core accelerator is difficult.

In a case of a DNN program, there is a big difference in execution time depending on the compiler optimization scheme. However, in the related art, the performance is estimated according to a given data flow, and thus, the performance change according to the compiler optimization may not be reflected. Accordingly, there may be a limitation that the estimation of performance according to various compiler optimization techniques may be difficult.

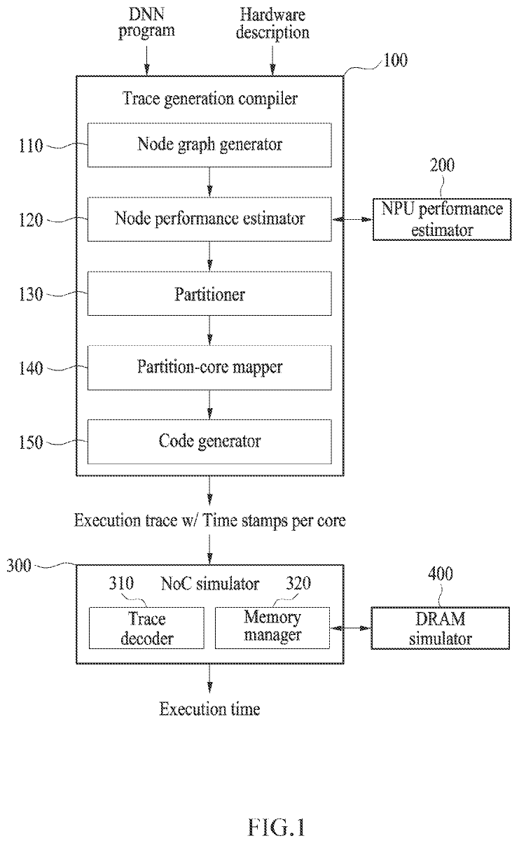

FIG. 1 is a diagram illustrating an example of an apparatus for estimating execution time of a neural network.

The apparatus for estimating execution time of a neural network, according to an example, may include a trace generation compiler 100 and a network on chip (NoC) simulator 300. Hereinafter, for ease of description, the trace generation compiler 100 may be referred to as a “compiler 100”.

The apparatus for estimating execution time of a neural network, according to an example, may estimate the execution time of the neural network by reflecting a structure of a multi-core accelerator and a compiler optimization technique. In this example, the neural network may refer to a general model that has an ability to solve a problem or perform tasks, as non-limiting examples, where nodes form the network through connections and other parameter adjustment through training. The neural network model may be implemented through one or more a neural network program, i.e., instructions or software to control a processor or computer to implement the neural network model.

The compiler 100 according to an example may generate trace information including operation timing information of the neural network for each core of the multi-core accelerator. More specifically, the compiler 100 may receive the neural network and a hardware description, generate code to be executed by each core by automatically parallelizing the neural network to fit the multi-core accelerator, insert communication code between cores by identifying a program dependency relationship, and add a command to read and write, in a memory, input data, output data, and a weight that are utilized in each artificial neural network layer.

The NoC simulator 300 according to an example may calculate the execution time of the neural network reflecting communication overhead between the cores of the multi-core accelerator and memory access time for each core, based on the trace information.

More specifically, the NoC simulator 300 may estimate the execution time for each core, based on code for each core generated by the compiler 100, and a memory command, while estimating performance of the multi-core accelerator by reflecting the communication overhead between the cores to fit communication code generated by the NoC simulator 300 and the compiler 100.

The compiler 100 according to an example may include a node graph generator 110, a node performance estimator 120, a partitioner 130, a partition-core mapper 140, and a code generator 150.

The node graph generator 110 according to an example may generate one or more nodes for each layer of the neural network, and generate a node graph corresponding to the neural network by connecting a data dependency between nodes via an edge.

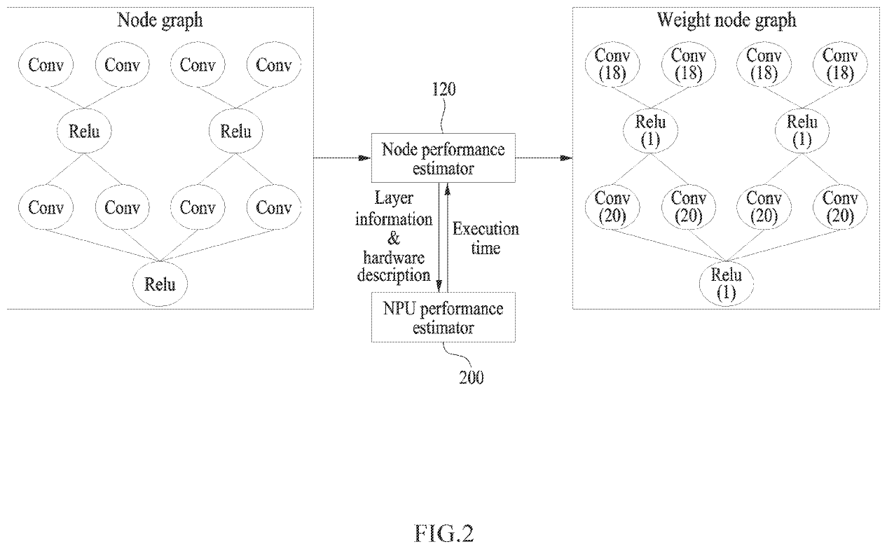

The node performance estimator 120 according to an example may estimate the execution time of each node by using an accelerator performance estimator 200 (e.g., an NPU performance estimator). An operation method of the node performance estimator 120 is described in detail with reference to FIG. 2.

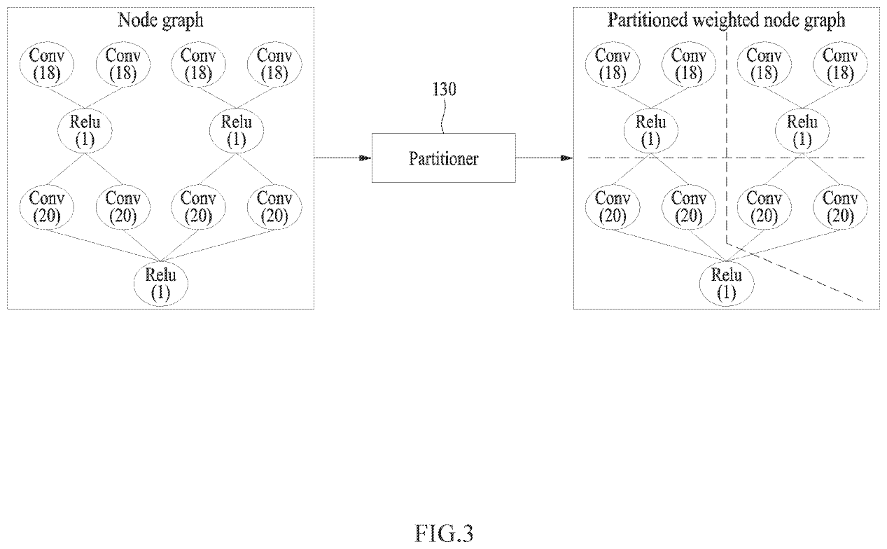

The partitioner 130 according to an example may partition the node graph according to a criterion, based on the execution time for each node and a size of input and output data between the nodes. An operation method of the partitioner 130 is described in detail with reference to FIG. 3.

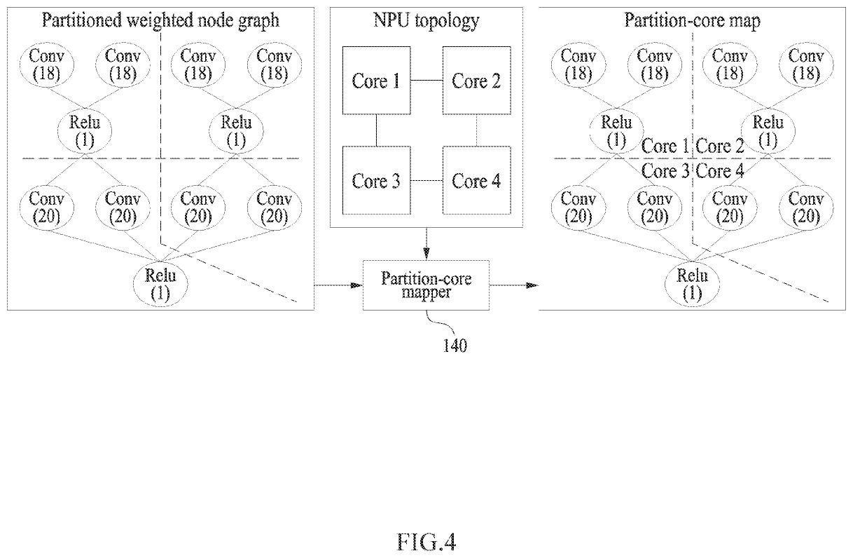

The partition-core mapper 140 according to an example may assign partitions generated by the partitioner 130 to the nodes according to a criterion. An operation method of the partition-core mapper 140 is described in detail with reference to FIG. 4.

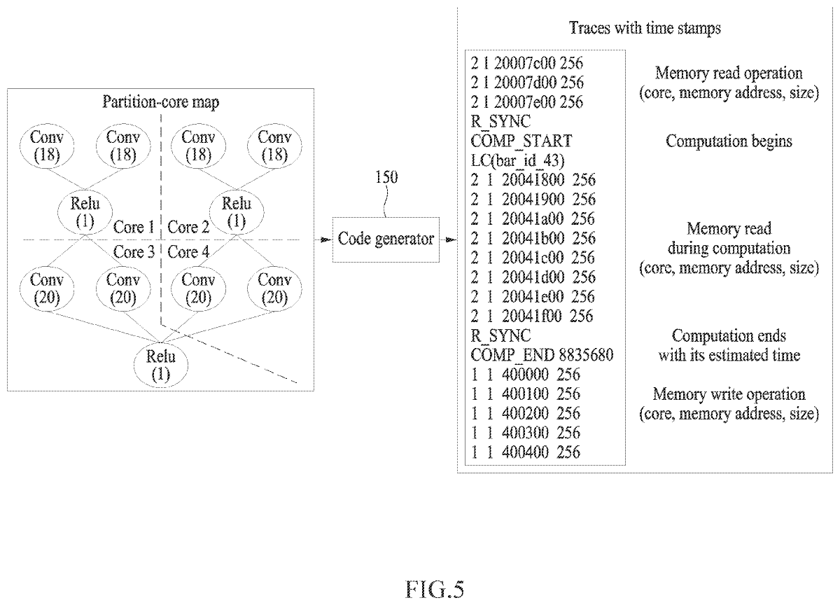

The code generator 150 according to an example may generate trace code including the operation timing information for each core to which the plurality of cores are assigned, such that the plurality of partitions are executed. An operation method of the code generator 150 is described in detail with reference to FIG. 5.

The NoC simulator 300 according to an example may include a trace decoder 310 and a memory manager 320. The NoC simulator 300 may calculate the execution time of the neural network reflecting the communication overhead between the cores of the multi-core accelerator and the memory access time for each core, by interworking with a memory simulator 400 (e.g., a DRAM simulator).

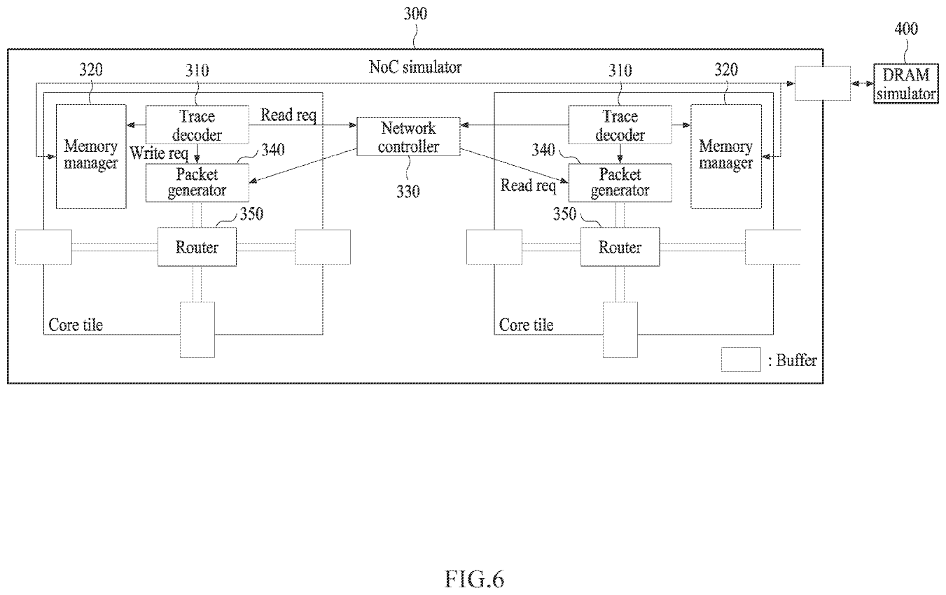

The trace decoder 310 may execute the NoC simulator 300 by converting the trace information generated by the compiler 100 into an input value of the NoC simulator 300. In this example, for a memory operation, the NoC simulator 300 may calculate the memory access time and reflect the calculated memory access time in the execution time, by interworking with the memory simulator 400 through the memory manager 320. An operation method of the NoC simulator 300 is described in detail with reference to FIG. 6.

FIG. 2 illustrates an example of a method of operating the node performance estimator.

Referring to FIG. 2, the node performance estimator 120 according to an example may extract operation information of a neural network, based on a node graph generated by the node graph generator 110. More specifically, the node performance estimator 120 may extract the operation information, based on a dimension of input data, output data, and a weight tensor of each layer and a loop nest structure of the layer.

For example, for a convolution layer of the neural network, the node performance estimator 120 may extract an operation type, the loop nest structure, and iteration space information, such as CONV/K:64, C:64, R:1, S:1, Y: 56, X:56/Stride: 1.

Furthermore, the node performance estimator 120 may acquire a hardware description, transmit the operation information and the hardware description to the accelerator performance estimator 200, and acquire estimated execution time for each layer that is needed to execute the respective layers from the accelerator performance estimator 200.

The accelerator performance estimator 200 may estimate the execution time required for a single-core accelerator to execute the respective layers for the operation information and the hardware description by utilizing a conventional NPU performance estimation framework, such as Timeloop or MAESTRO.

Also, the node performance estimator 120 may generate a weighted node graph based on the estimated execution time for each layer. The node performance estimator 120 may estimate (e.g., 20 μs) the execution time for each layer, and generate the weighted node graph by adding the estimated execution time as a weight of a corresponding node.

For example, in FIG. 2, when the estimated execution time of a first ReLu layer is 1 μs, the estimated execution time of a first convolution layer is 20 μs, the estimated execution time of a second ReLu layer is 1 μs, and the estimated execution time of a second convolution layer is 18 μs, the node performance estimator 120 may generate the weighted node graph in which each of the estimated execution times is added as a weight of the node included in a corresponding layer.

FIG. 3 illustrates an example of a method of operating a partitioner.

Referring to FIG. 3, the partitioner 130 according to an example may partition a weighted node graph into a plurality of partitions, based on estimated execution time for each layer and a size of input and output data between nodes. Specifically, the partitioner 130 may partition the weighted node graph into the plurality of partitions such that the execution time of each of the plurality of partitions has a difference equal to or less than a threshold. For example, the partitioner 130 may partition the weighted node graph into the plurality of partitions such that the plurality of partitions have the same execution time.

The partitioner 130 according to an example may set each of the nodes as a single preliminary partition, and merge the preliminary partition until the number of final partitions is less than the number of cores, based on a balanced graph partitioning algorithm. For example, in FIG. 3, the partitioner 130 may partition the weighted node graph into four partitions.

FIG. 4 illustrates an example method of operating a partition-core mapper.

Referring to FIG. 4, the partition-core mapper 140 according to an example may assign a plurality of partitions to cores such that communication overhead between the plurality of partitions becomes equal to or less than a predetermined threshold. For example, the partition-core mapper 140 may assign the plurality of partitions to the cores such that the communication overhead between the plurality of partitions is minimized.

The partition-core mapper 140 may map the partitions having a large amount of communication to adjacent cores, based on accelerator topology information (e.g., NPU topology information) included in a hardware description. For example, in FIG. 4, the partition-core mapper 140 may assign Core 1 to an upper left partition, assign Core 2 to an upper right partition, assign Core 3 to a lower left partition, and assign Core 4 to a lower right partition.

Through such assignments, a delay due to communication contention between the cores may reduce, and a bandwidth between the cores may be efficiently used.

FIG. 5 illustrates an example of a method of operating a code generator.

Referring to FIG. 5, the code generator 150 according to an example may generate trace code including operation timing information for each core to which a plurality of partitions are assigned, such that the plurality of partitions are executed.

More specifically, the code generator 150 according to an example may generate trace code including at least one of a read/write command including a memory address and a data size, data movement information between cores, and operation timing information performed in each core.

The operation timing information performed in each core may be generated by reflecting a result of the accelerator performance estimator 200 (e.g., the NPU performance estimator), without considering memory input and output time and communication overhead.

FIG. 6 illustrates an example of a method of operating an NoC simulator.

Referring to FIG. 6, the NoC simulator 300 according to an example may calculate execution time reflecting network contention and memory access time (e.g., the DRAM access time) for trace information for each core, by interworking with the memory simulator 400 (e.g., the DRAM simulator).

The NoC simulator 300 may include the trace decoder 310, the memory manager 320, a network controller 330, a packet generator 340, and a router 350.

The trace decoder 310 according to an example may execute the NoC simulator 300 by analyzing the trace information generated by the compiler 100 for each core. In an example, the NoC simulator 300 for measuring network contention to estimate performance may use a conventional NoC simulator, such as RingoStar or Noxim.

For a memory operation, the memory manager 320 according to an example may calculate memory access time according to the memory address and a size, and reflect the calculated memory access time in the execution time, by interworking with the memory simulator 400 (e.g., the DRAM simulator).

For a communication command between cores, in a case of a command to transmit data, the trace decoder 310 may directly transmit a write request to the packet generator 340 to generate a write packet, and transmit the packet through the router 350.

When data in another core is read, the trace decoder 310 may transmit a read request to the network controller 330, and the network controller 330 may transmit the read request to the packet generator 340 of a target core to generate a read packet and receive the packet including corresponding data through the router 350.

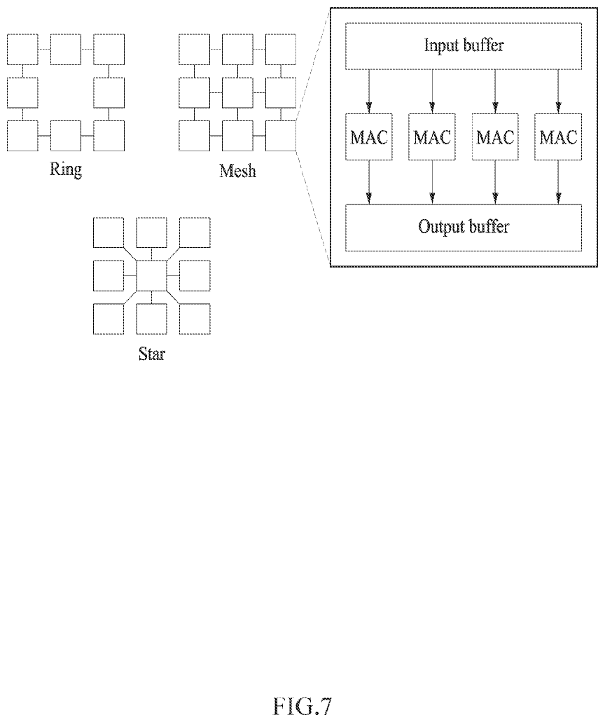

FIG. 7 illustrates an example of a design space of a multi-core accelerator.

Referring to FIG. 7, an apparatus for estimating execution time of a neural network, according to an example, may assist in developing an optimal accelerator (e.g., an NPU) through an estimation of the execution time of the neural network reflecting a structure of a multi-core accelerator.

In a multi-core NPU, there exist a single-core design space, such as a size of an input/output buffer and a scale of a MAC, and an NPU design space, such as various connection topologies, for example, a ring, a mesh, and a star.

The apparatus for estimating execution time of a neural network according to an example may provide help to develop an optimal NPU by supporting the estimation of performance for various hardware (HW) design spaces.

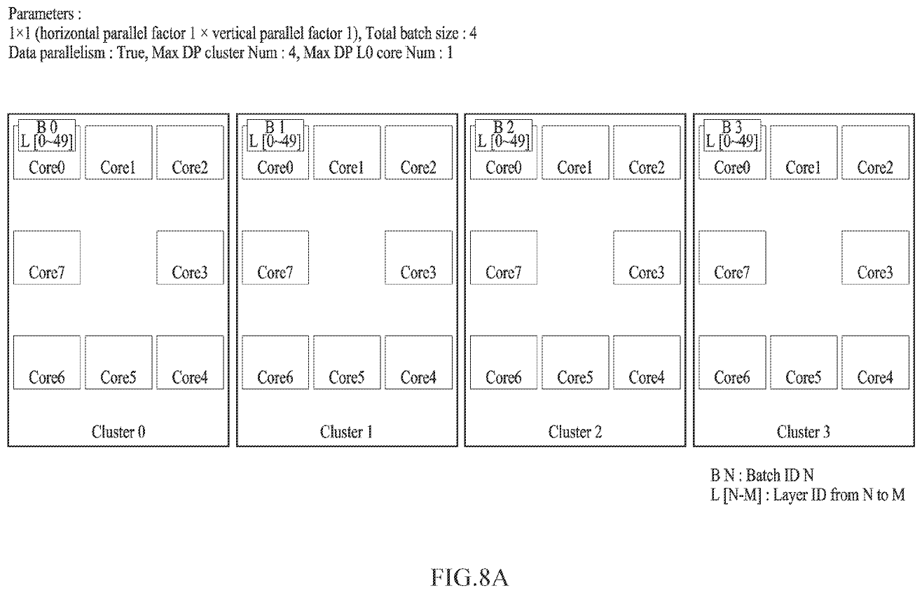

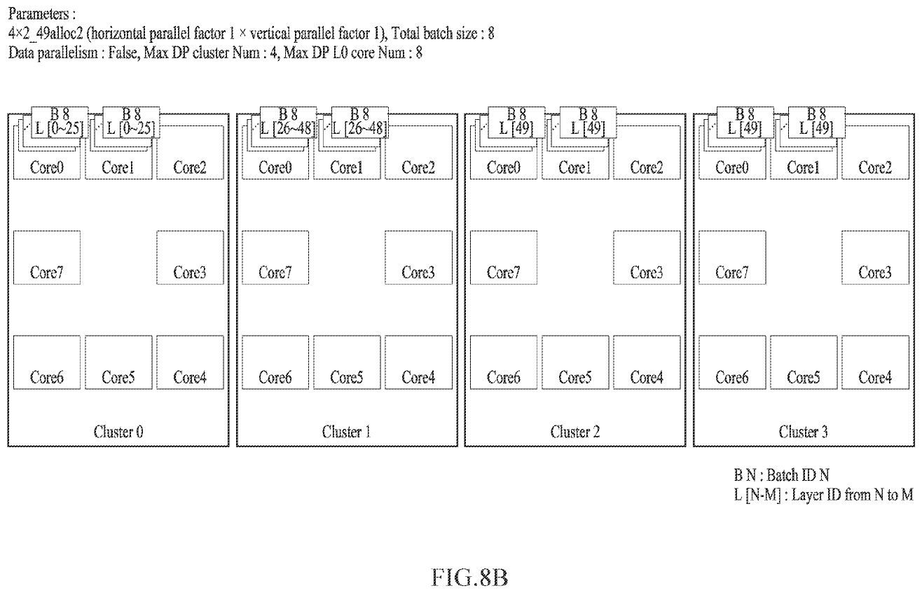

FIGS. 8A and 8B illustrate examples of an estimation of performance for parallelism.

FIG. 8A illustrates an example of data parallelism of batch-level parallelism. Since the same type of node graphs is equally assigned to different cores, different batches may be performed.

FIG. 8B illustrates an example of layer parallelism of batch-level parallelism. Based on a layer partitioned through model parallelism, a layer pipeline may be supported by placing the batch on the partitioned layer.

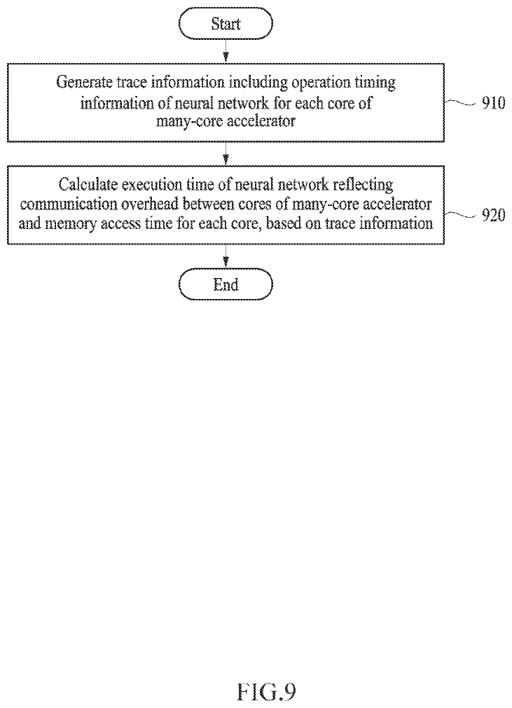

FIG. 9 is a diagram illustrating an example of a method of estimating execution time of a neural network. The operations in FIG. 9 may be performed in the sequence and manner as shown, although the order of some operations may be changed or some of the operations omitted without departing from the spirit and scope of the illustrative examples described. Many of the operations shown in FIG. 9 may be performed in parallel or concurrently. One or more blocks of FIG. 9, and combinations of the blocks, can be implemented by special purpose hardware-based computer, such as a processor, that perform the specified functions, or combinations of special purpose hardware and computer instructions.

Descriptions provided with reference to FIGS. 1 through 8 may be applicable to a description provided with reference to FIG. 9, and thus, repeated description thereof is omitted.

In operation 910, an apparatus for estimating execution time of a neural network may generate trace information including operation timing information of the neural network for each core of a multi-core accelerator.

In operation 920, the apparatus for estimating execution time of a neural network may calculate the execution time of the neural network reflecting communication overhead between cores of the multi-core accelerator and memory access time for each core, based on the trace information.

The trace generation compiler 100, the accelerator performance estimator 200, the network on chip (NoC) simulator 300, the node graph generator 110, the node performance estimator 120, the partitioner 130, the partition-core mapper 140, the code generator 150, the trace decoder 310, the memory manager 320, the network controller 330, the packet generator 340, and the router 350, and other apparatuses, devices, units, modules, and components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, multiple-instruction multiple-data (MIMD) multiprocessing, a controller and an arithmetic logic unit (ALU), a DSP, a microcomputer, an application-specific integrated circuit (ASIC), a field programmable gate array (FPGA), a programmable logic unit (PLU), a central processing unit (CPU), a graphics processing unit (GPU), a neural processing unit (NPU), or any other device capable of responding to and executing instructions in a defined manner.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

The Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In an example, the instructions or software includes at least one of an applet, a dynamic link library (DLL), middleware, firmware, a device driver, an application program storing the method of estimating execution time of a neural network. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), magnetic RAM (MRAM), spin-transfer torque (STT)-MRAM, static random-access memory (SRAM), thyristor RAM (T-RAM), zero capacitor RAM (Z-RAM), twin transistor RAM (TTRAM), conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, molecular electronic memory device), insulator resistance change memory, dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions. In an example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A processor-implemented method of estimating execution time of a neural network in a multi-core accelerator, the method comprising:
generating trace information comprising operation timing information for each core of the multi-core accelerator; and
calculating the execution time of the neural network reflecting communication overhead between cores of the multi-core accelerator and memory access time for each core of the cores, based on the trace information.

2. The method of claim 1, wherein the generating of the trace information comprises generating one or more nodes for each layer of the layers of neural network, and generating a node graph corresponding to the neural network by connecting a data dependency between the one or more nodes via an edge.

3. The method of claim 2, wherein the generating of the trace information comprises:
extracting operation information of the neural network based on the node graph;
acquiring a hardware information;
determining estimated execution time for the each layer based on the operation information and the hardware information; and
generating a weighted node graph based on the estimated execution time for the each layer.

4. The method of claim 3, wherein the determining of the estimated execution time comprises determining the estimated execution time for a single-core accelerator to execute the layers.

5. The method of claim 3, wherein the generating of the weighted node graph comprises generating the weighed node graph by adding the estimated execution time for the each layer as a node weight of the node graph.

6. The method of claim 3, wherein the generating of the trace information comprises partitioning the weighted node graph into a plurality of partitions, based on the estimated execution time for the each layer and a size of input and output data between the nodes.

7. The method of claim 6, wherein the partitioning of the weighted node graph comprises partitioning the weighted node graph into the plurality of partitions based on the execution time of each of the plurality of partitions having a difference equal to or lesser than a threshold time.

8. The method of claim 6, wherein the partitioning of the weighted node graph comprises:
setting each of the nodes as a single preliminary partition; and
merging the preliminary partition until a number of final partitions becomes less than a number of cores, based on a balanced graph partitioning algorithm.

9. The method of claim 6, wherein the generating of the trace information comprises assigning the plurality of partitions to the cores to make communication overhead between the plurality of partitions equal to or lesser than a threshold.

10. The method of claim 9, wherein the assigning of the plurality of partitions comprises mapping partitions having a large amount of communication to adjacent cores, based on accelerator topology information included in the hardware information.

11. The method of claim 9, wherein the generating of the trace information comprises generating trace code comprising the operation timing information for each core to execute the plurality of partitions that are assigned to the each core.

12. The method of claim 11, wherein the generating of the trace code comprises generating the trace code that comprises at least one of a read/write command comprising a memory address and a data size, data movement information between the cores, or operation timing information performed in each core.

13. The method of claim 1, wherein the calculating of the execution time of the neural network comprises executing a network on chip (NoC) simulator by decoding the trace information.

14. The method of claim 1, wherein the calculating of the execution time of the neural network comprises:
acquiring the memory access time for each core, based on at least one of a memory address or a size; and
acquiring read information and write information between the cores based on the trace information.

15. The method of claim 14, wherein the acquiring of the memory access time comprises acquiring the memory access time for each core by interworking with a memory simulator.

16. The method of claim 14, wherein the acquiring of the read information and the write information comprises:
generating a write packet based on the trace information, and transmitting the write packet through a router;
transmitting a read request to a network controller, based on the trace information,
transmitting, by the network controller, the read request to a target core to generate a read packet, and
receiving the read packet through the router.

17. A non-transitory computer-readable storage medium storing instructions that, when executed by a processor, cause the processor to perform the method of claim 1.

18. An apparatus for estimating execution time of a neural network, the apparatus comprising:
a compiler configured to generate trace information comprising operation timing information of the neural network for each core of a multi-core accelerator; and
a simulator configured to calculate the execution time of the neural network reflecting communication overhead between cores of the multi-core accelerator and memory access time for each core of the cores, based on the trace information.

19. The apparatus of claim 18, wherein the compiler is further configured to:
determine estimated execution time for each layer of the neural network based on operation information of the neural network and a hardware information of the multi-core accelerator, and to generate a weighted node graph based on the estimated execution time for the each layer.

20. The apparatus of claim 18, wherein the simulator is further configured to:
acquire the memory access time for each core, based on at least one of a memory address or a size, and to acquire read information and write information between the cores, based on the trace information.
